(19) United States
(12) Patent Application Publication
(10) Pub. No.: US 2016/0238232 A1
(43) Pub. Date: Aug. 18, 2016

(54) ILLUMINATED DISPLAY APPARATUS

(71) Applicants: Jordan Eubanks, Los Angeles, CA (US); David Kamiar Golbahar, Beverly Hills, CA (US)

(72) Inventors: Jordan Eubanks, Los Angeles, CA (US); David Kamiar Golbahar, Beverly Hills, CA (US)

(21) Appl. No.: 14/620,567

(22) Filed: Feb. 12, 2015

(51) Int. Cl. F21V 29/83; A42B 3/04; F21S 9/02; F21V 33/00; F21S 4/00

(52) U.S. Cl. CPC F21V 29/83; F21V 33/0008; F21S 4/003; F21S 9/02; A42B 3/044; F21W 2121/06

(57) ABSTRACT

An illuminated light display apparatus having an outer shell in the shape of a sporting good or other design is provided. For example, the outer shell may appear in the shape of a football helmet. A second, inner layer is also provided, and a collection of lighting elements, such as LEDs, is disposed between the second layer and outer shell. The outer shell has at least one cutout penetrating through to the inner layer to expose the collection of lighting elements. Moreover, both the outer shell and inner layer may feature additional vents to dissipate heat generated by the collection of lighting elements.

### GOVERNMENT CONTRACT

Not applicable.

### CROSS-REFERENCE TO RELATED APPLICATIONS

None.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material that is subject to copyright protection. This patent document may show and/or describe matter that is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to lighting fixtures, and more particularly, to a layered combination of components for incorporating illuminating elements into the body of an ornamental fixture.

### BACKGROUND

A desire to enhance the aesthetic appeal of one's dwelling or workplace using ornamental displays which communicate personal interests is well documented in the art. Indeed, many choose to personalize such spaces with features that include logos and other elements that communicate an affinity for various competitive sports. For example, U.S. Pat. No. 7,339,865 to Hardesty discloses a clock that features various interchangeable indicia of popular sports, such as soccer, on its face; U.S. Pat. No. 6,578,214 to Peftoulidis discloses a bed frame molded into the shape of a football; and U.S. Pub. No. 2013/0049412 filed by Fisher describes a spherical lounge chair that resembles a sports ball. Many of these may be further adapted to communicate support for a specific sports team by including the logo or name of the supported team in a visible position on the display.

Some ornamental sports displays have included illuminated elements. For example the aforementioned patent to Peftoulidis discloses the use of a night-light on the molded bed frame. Still, it has been difficult to incorporate such elements into the bodies of the displays themselves because doing so may trap heat emitted by any lighting elements contained within display. Any trapped heat may, in turn, damage various other parts of the display and create a significant risk to the person and property adjacent to or within a certain proximity. This can be especially true for ornamental displays of realistic-looking paraphernalia. For example, a consumer may wish to display a lighted football helmet. Unfortunately, real football helmets comprise one or more layers of opaque, protective material. Opaque materials, by definition, fail to transmit light, and often trap heat as insulators. Unadapted for use with lighting elements, such designs both trap heat and also fail to provide any ornamental illumination.

These shortcomings have led to significant limitations on the types of lighting displays presently available to consumers. Thus, there is a need for an apparatus adapted to incorporate lighting elements into the body of an ornamental display while eliminating the hazards that would otherwise result. Additionally, there is a need for a lighting apparatus that allows users to visually communicate an affinity for a competitive sport or support for a particular team.

### SUMMARY

The present invention is directed to an illuminated display apparatus. In particular, such a display may be formed to appear as a realistic, lighted rendition of an object, such as a sporting apparatus, as desired by a consumer while providing ventilation for any lighting elements contained therein.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the illuminated display apparatus comprises a first layer and a second layer. In particular, the first layer may define an outer shell formed into any desirable shape. For example, many consumers decorate their homes and offices with sporting paraphernalia to communicate their affinity for a particular competitive sport or team. Thus, it is contemplated that the outer shell of the illuminated display apparatus may be formed into the shape of a football helmet, football, baseball cap, golf ball, tennis ball, or baseball, jersey, or any other sporting apparatus. However, one skilled in the art will recognize that the illuminated display apparatus is not limited to such configurations. The outer shell may be formed into any desired shape, including but not limited to life-like models of animals, for example, or even ornamental or otherwise decorative shapes, such as a swirl, starburst, globe, or any other shape desired by a consumer.

The second layer has a top side and a bottom side and flexibly conforms to the inside of the outer shell defined by the first layer. The second layer may be secured in a position contiguous to the inside of the outer shell with fasteners chosen from, for example, double stick tape, glue, and even hook and loop fasters. In an embodiment, the first layer may be formed so that the illuminated display apparatus is open along a bottom end. The open bottom may leave the inner layer exposed for mounting the illuminated display apparatus. For example, in a preferred embodiment, the illuminated display apparatus may be disposed as a decorative, lighted topper for a Christmas tree. Of course, the applicability of the illuminated display apparatus is not limited to Christmas-time or even to mounting on trees. The open end of the illuminated display apparatus may accommodate various mounting mechanisms and may even allow the illuminated display apparatus to rest as a decorative ornament on a shelf.

A collection of lighting elements, such as light emitting diodes (LEDs), are disposed between the outer shell and second layer. In one embodiment, the LEDs may be arranged on electrically conducting strips or ribbons or even boards as are well known to those skilled in the art and available in the marketplace. In another embodiment, the collection of lighting elements may be electroluminescent wiring.

It is contemplated that the first layer defining the outer shell comprises material such as opaque plastic to visually depict the object formed by the outer shell. Thus, in order to light the illuminated display apparatus, the outer shell further comprises at least one cutout penetrating the first layer to expose the collection of lighting elements disposed between the first and second layers. Rather than mounting lights on the outer surface of the illuminated display apparatus, which may interrupt the aesthetic effect achieved by the formation of the outer shell, the collection of lighting elements may be disposed within the illuminated display apparatus so that the display itself appears to emanate light.

The first and second layers may additionally comprise one or more vents which penetrate through both the first and second layers of the illuminated display apparatus. In particular, it is contemplated that providing vents in this manner may allow heat naturally generated by the collection of lighting elements to dissipate, rather than collect in a the materials comprising the first and second layers or even a cavity defined by the first and second layers. Vented in this manner, moreover, there is a decreased risk of overheating the display by disposing the lights between the first and second layers. It is even further contemplated that the open bottom of the illuminated display apparatus also provides ventilation to ensure that heat from the collection of lighting elements is able to escape from the illuminated display apparatus.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of an embodiment of the illuminated display apparatus.

FIG. 2 shows a side perspective view of the embodiment of the illuminated display apparatus play from FIG. 1.

FIG. 3 shows a rear perspective views, respectively, of the embodiment of the illuminated display apparatus from FIG. 1.

FIG. 4 is a cross-sectional view of an embodiment of the illuminated display apparatus.

FIG. 5 illustrates an exploded view of an embodiment of the illuminated display apparatus.

The disclosed embodiments may be better understood by referring to the figures in the attached drawings, as provided below. The attached figures are provided as non-limiting examples for providing an enabling description of the claimed apparatus. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

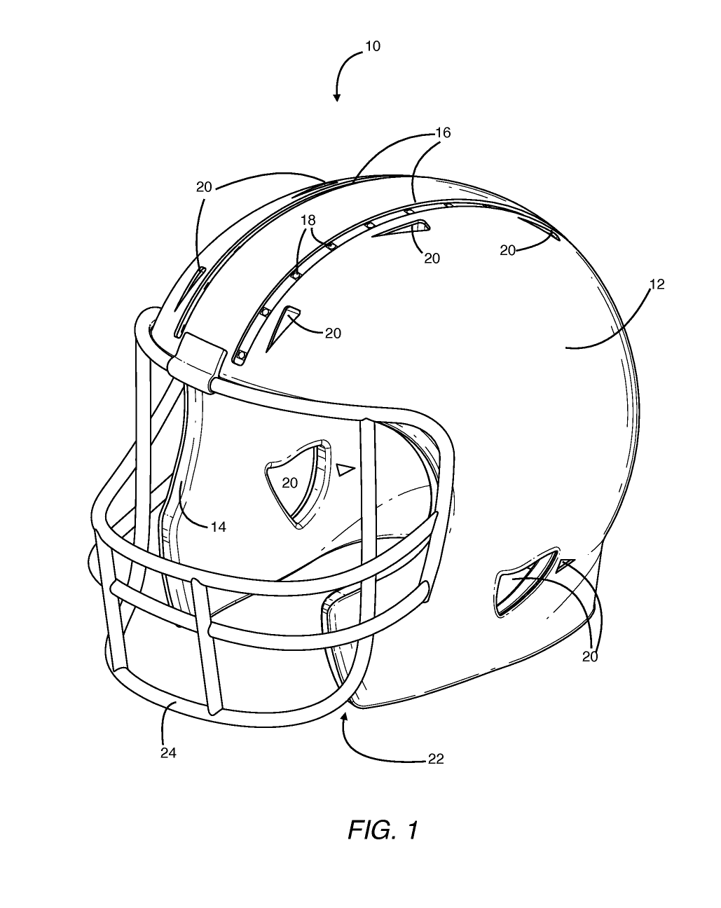

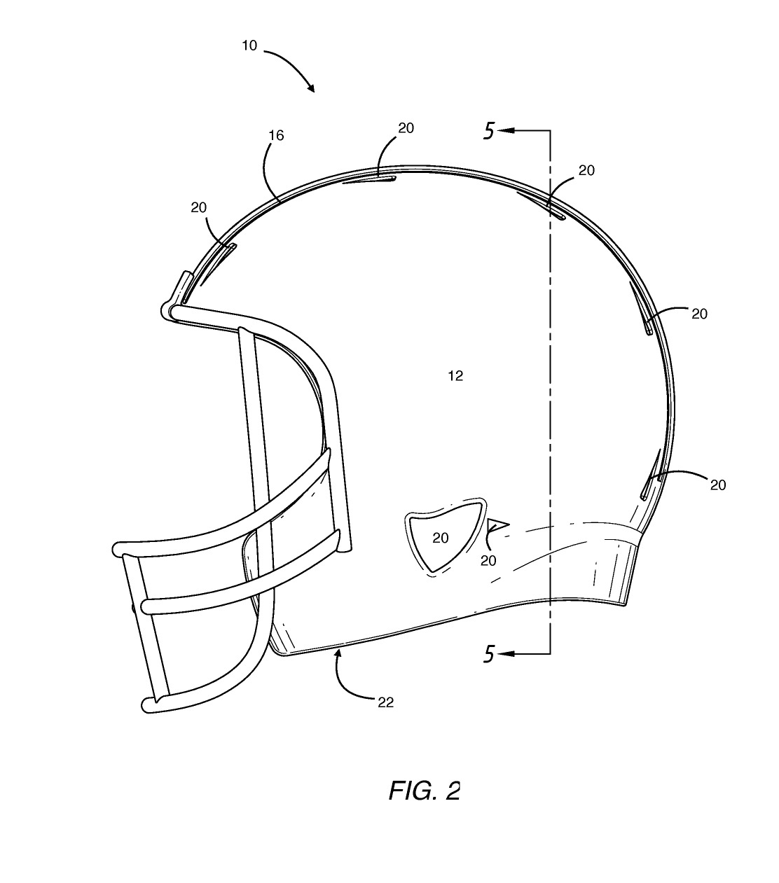

With reference to FIGS. 1-3, the illuminated display apparatus 10 is shown in the form of a realistic football helmet having at least a first layer 12, and a second layer 14, one or more cutouts 16 exposing a collection of lighting elements 18, and cooling vents 20.

The first layer 12 is formed to define an outer shell. In one embodiment, this outer shell may be the shape of a football helmet 10 as in the appended figures, even comprising such elements as a protective grill 24. Still, it is, of course, understood that this is done for ease of illustration only, and not of limitation. One skilled in the art will recognize that the illuminated display apparatus may be formed into any ornamental design that a consumer desires. For example, it is contemplated that the first layer 12 may be formed to define an outer shell in the shape of other sporting apparatuses, such as various sporting balls, hats, jerseys, equipment, and any other sporting goods desired by a consumer. Moreover, the outer shell may be decorated with paint, dye, colored plastic, or any other decorating elements with any logos, insignia, team names or other designs attributable to and recognizable for the particular sport. Thus, a consumer displaying the illuminated display apparatus is able to visually communicate his or her affinity for a particular sport or even support for a particular team by displaying the illuminated display apparatus. Of course, the first layer 12 of the illuminated display apparatus is not limited to forms relating to competitive sports. A consumer may wish to exhibit an illuminated display apparatus in the shape of one or more animals, buildings, or even in the shape of an utterly ornamental design. Thus, the outer shell, defined by the first layer 12 of the illuminated display apparatus 10 should not be limited to the form of a football helmet as depicted, but may take any form desired by a consumer.

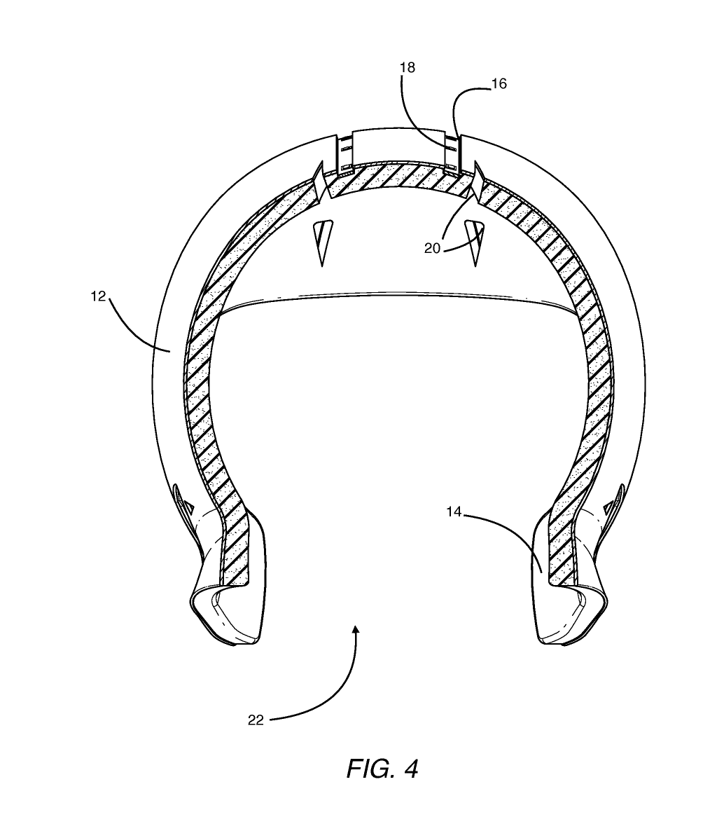

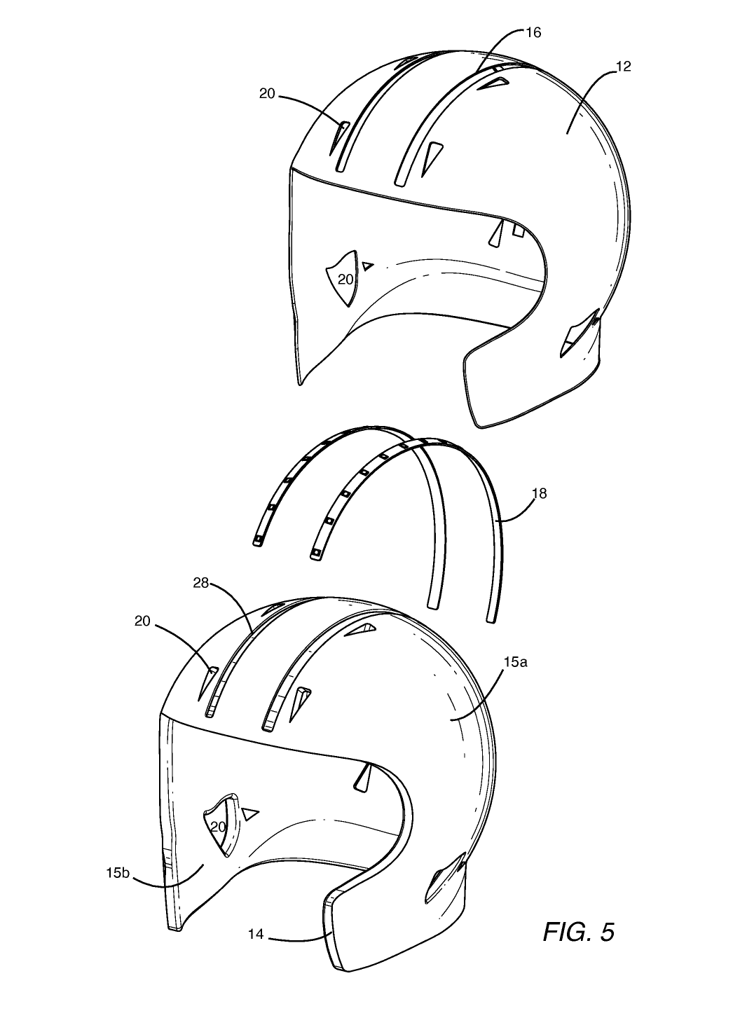

With attention to FIGS. 4 and 5, the illuminated display apparatus further comprises a second layer 14 having a top side 15a and a bottom side 15b. The second layer 14 flexibly conforms to the inside of the outer shell within the cavity and is arranged so that the top side 15a of the inner layer is positioned contiguous with the inside of the outer shell. The second layer 14 may comprise foam, such as open-cell polyurethane foam or closed-cell polyethylene foam, of any desirable density. In a preferred embodiment, the foam is about 0.25 to about 1.25 inches thick. The foam comprising the second layer 14 may be either permanently or removably adhered to the inside of the first layer 12. For example, it is contemplated that double stick tape, glue, or even hook and loop fasteners be applied to the inside of the first layer 12 and/or the top side 15a of the second layer 14 so that the first layer 12 and second layer 14 are contiguously joined with one another.

At least one cutout 16 penetrates the first layer 12 in order to expose the collection of lighting elements 18 which are disposed between the first layer 12 and the second layer 14. This is more clearly illustrated with reference to the exploded view of FIG. 5. Each cutout 16 permits light from the collection of lighting elements 18 to pass through the outer shell defined by the first layer 12 in order to illuminate the display apparatus 10. In a preferred embodiment, the lighting elements disposed between the first layer 12 and second layer 14 comprise a plurality of LEDs. Such LEDs may be arranged on one or more strips or ribbons adapted to conduct electricity to light the LEDs, as are commonly known in the marketplace. In another embodiment, LEDs may be arranged on well-known LED boards. Although only two strips of parallel lighting elements 18 are shown in FIG. 5, it should be apparent to one skilled in the art that this is for the simplicity of illustration, and the collection of lighting elements 18 disposed between the first and second layers 12, 14 may be physically arranged in any configuration and with as many lights as may be desirable to facilitate illuminating the disclosed apparatus. Likewise, the cutouts 16 may be physically arranged in any configuration available to permit light from the collection of lighting elements 18 to pass through the outer shell defined by the first layer 12.

Indeed is contemplated that providing cutouts 16 in this manner will allow the outer shell to be formed into more realistic-looking figures than previously achieved. For example, it is not possible, by definition, for light to pass through opaque materials. However, providing one or more cutouts 16 allows light to illuminate the display apparatus formed to realistically represent some object that naturally appears opaque, such as the football helmet illustrated. In a preferred embodiment, disposing the collection of lighting elements 18 between the first layer 12 and second layer 14 further avoids interfering with the outward, aesthetic appeal of the illuminated display apparatus 10.

It is further contemplated that the collection of lighting elements 18 may be colored, or not, depending on the particular shape formed by the outer shell defined by the first layer 12 of the illuminated display apparatus 10. For example, if an illuminated display apparatus is provided in the shape of a football helmet, and more particularly, the football helmet depicts particular team colors or team logos, then the LEDs disposed between the first and second layers 12, 14 may be chosen so that the lights coordinate with the team colors or team logos. In other words, an illuminated display apparatus shaped as a football helmet that visually communicates support for a team with a predominantly orange logo may include a collection of orange lighting elements. In another example, if an illuminated display apparatus is provided in the shape of an animal such as a dolphin, the color of the collection of lighting elements may be chosen as blue or white, or any other color that would complement the skin tone of a dolphin. Such colors, however, are offered only for the purposes of illustration and should not be read to limit the invention in any way. It is contemplated that the collection of lighting elements 18 comprise any colors, combination of colors, or no colors as desired.

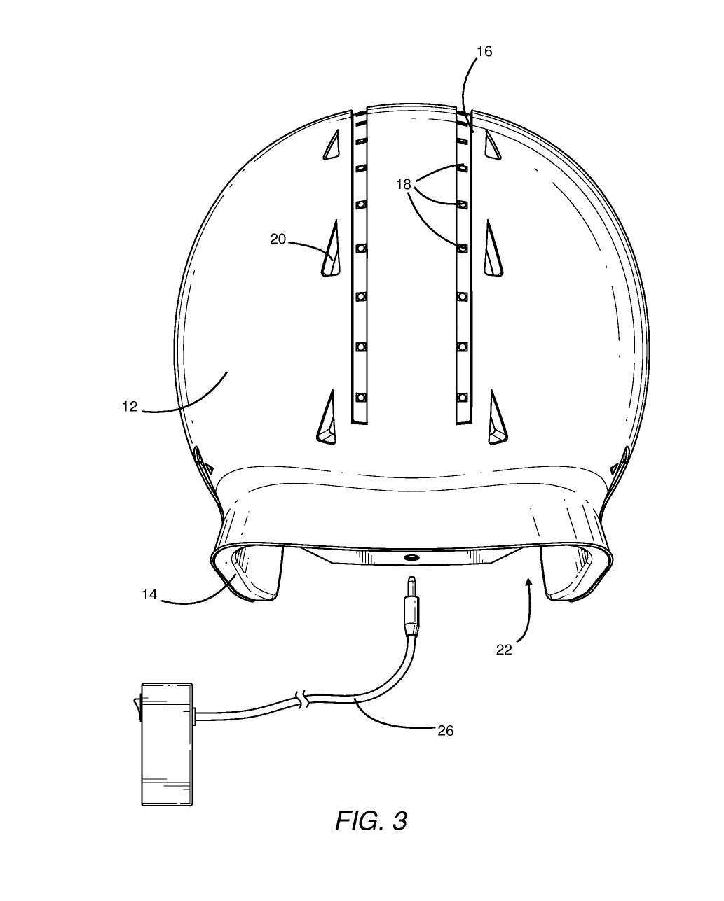

The illuminated display apparatus 10 may further comprise a power source 22, an embodiment of which is shown in FIG. 3. It is contemplated that the power source 26 may be electrically coupled to the collection of lighting elements 18 so that a consumer may optionally illuminate the display apparatus 10. The power source 26 may be a battery pack (shown), an electrically conducting wire adapted to plug in to a typical wall outlet, or a power source housed within the cavity defined by the first layer 12. It is even contemplated that one or more solar panels may be disposed along or within portions of the illuminated display apparatus that may be exposed to natural light. For example, in one embodiment, the first layer 12 may be transparent. Thus one or more solar panels may be disposed beneath the first layer to provide energy generated from incidental sun or other light exposure to the collection of lighting elements 18. Of course it is contemplated, and one skilled in the art will recognize, that the novel features of the invention may be achieved with a variety of power sources, and the foregoing are provided as non limiting examples of such power sources.

Returning attention to FIG. 5, the exploded view of an embodiment of the illuminated display apparatus illustrates one or more recessed segments 28 sized to accommodate the collection of lighting elements 18 in their position between the first and second layers 12, 14.

The illuminated display apparatus 10 is open along a bottom end 22. In an embodiment, this allows access to a cavity defined by the contiguous first and second layers, and more particularly, allows a consumer to mount his or her illuminated display apparatus on a variety of objects or surfaces. For example, in one embodiment, an illuminated display apparatus may be placed as a topper on a seasonal Christmas tree. In such an embodiment, a topmost, vertical branch of the tree may be slipped into the cavity through the bottom end 22, leaving the illuminated display apparatus 10 to balance on top of the tree. In another embodiment, the open bottom acts as a ventilator, allowing heat from the collection of lighting elements 18 to dissipate. This prevents damage to the display, lighting elements themselves, and surrounding environment that may be caused by accumulated heat. The second layer 14, moreover, acts as a cushion to protect the collection of lighting elements 18 from damage that may be caused by mounting the illuminated display apparatus 10 on various objects and surfaces. For example, if mounted on a tree as a Christmas tree topper, the vertical branch, pine needles, and other typical features of the tree may scratch potentially delicate hardware associated with the collection of lighting elements 18. This may be particularly undesirable, and even dangerous, in consideration for the risk of fire associated with damaged electrical lighting.

In a preferred embodiment, the illuminated display apparatus 10 further comprises at least one vent 20 which penetrates both the first layer and the second layer 12, 14. In particular, it is contemplated that such vents may effect cooling of illuminated display apparatus 10 by allowing additional heat generated by the collection of lighting elements 18 to dissipate rather than collect and build in the cavity defined by the contiguous first and second layers 12, 14. As illustrated in FIGS. 1-5, the at least one vent 20 may penetrate the first and second layers 12, 14 along the one or more cutouts 16 and even near the open end 22 of the illuminated display apparatus 10. In particular, the proximity of the one or more vents 20 to the cutouts 16 may ensure that heat generated by the collection of lighting elements 18 has a near escape from within the cavity defined by the first and second layers. Still, it will be understood by one skilled in the art that neither the configuration of the vents 20 illustrated, nor the shape of the vents 20 shown are necessary to achieve this ventilation. Indeed, dissipating heat generated by the collection of lighting elements 18 that have been arranged in contemplated configurations not illustrated may be better served by arranging the vents 20 in various configurations as well.

### CONCLUSIONS, RAMIFICATIONS, AND SCOPE

While certain embodiments of the invention have been illustrated and described, various modifications are contemplated and can be made without departing from the spirit and scope of the invention. For example, the arrangement of the collection of lighting elements, cutouts, and vents may vary as desired. Indeed, there may more or less lights, housed in any number of configurations between the first and second layers. Accordingly, it is intended that the invention not be limited, except as by the appended claim(s).

The teachings disclosed herein may be applied to other systems, methods, and devices and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the illuminated display apparatus with which that terminology is associated. In general, the terms used in the following claims should not be constructed to limit the illuminated display apparatus to the specific embodiments disclosed in the specification unless the above description section explicitly define such terms. Accordingly, the actual scope encompasses not only the disclosed embodiments, but also all equivalent ways of practicing or implementing the disclosed apparatus. The above description of embodiments of the illuminated display apparatus is not intended to be exhaustive or limited to the precise form disclosed above or to a particular field of usage.

While specific embodiments of, and examples for, the device are described above for illustrative purposes, various equivalent modifications are possible for which those skilled in the relevant art will recognize.

While certain aspects of the device disclosed are presented below in particular claim forms, various aspects of the device are contemplated in any number of claim forms. Thus, the inventor reserves the right to add additional claims after filing the application to pursue such additional claim forms for other aspects of the illuminated display apparatus.

What is claimed is:

1. An illuminated display apparatus comprising:
a first layer defining an outer shell and cavity, the outer shell having an inside, an outside, an open bottom, and at least one cutout; and
a second layer having a top side and a bottom side, the second layer flexibly conforming to the inside of the outer shell within the cavity and arranged so that the top side of the second layer is positioned contiguous with the inside of the outer shell;
wherein a collection of lighting elements is disposed between the outer shell and second layer beneath the each of the at least one cutouts, each cutout permitting light to pass through the outer shell in order to illuminate the display apparatus.

2. The illuminated display apparatus of claim 1, wherein the outer shell further comprises at least one vent.

3. The illuminated display apparatus of claim 2, wherein the second layer further comprises a vent that penetrates the width of the second layer and corresponds to each of the at least one vents of the outer shell.

4. The illuminated display apparatus of claim 1, wherein the top side of the second layer has one or more recessed segments sized to accommodate any lighting elements disposed between the outer shell and second layer.

5. The illuminated display apparatus of claim 1, wherein any lighting elements disposed between the outer shell and second layer comprise light emitting diodes.

6. The illuminated display apparatus of claim 1, wherein the first layer is formed as a sporting apparatus.

7. The illuminated display apparatus of claim 6, further comprising a power source electrically coupled to any lighting elements to optionally illuminate the display apparatus.

8. An illuminated display apparatus comprising:
a first layer defining an outer shell and cavity, the outer shell having an inside, an outside, an open bottom, and at least one cutout; and
a second layer having a top side and a bottom side, the second layer flexibly conforming to the inside of the outer shell within the cavity and arranged so that the top side of the second layer is positioned contiguous with the inside of the outer shell;
wherein a collection of lighting elements is disposed between the outer shell and second layer beneath the each of the at least one cutouts, and a power source is electrically coupled to the lighting elements so that when the lighting elements are optionally powered on, each cutout permits light to pass through the outer shell in order to illuminate the display apparatus.

9. The illuminated display apparatus of claim 8, wherein the outer shell further comprises at least one vent.

10. The illuminated display apparatus of claim 9, wherein the second layer further comprises a vent that penetrates the width of the second layer and corresponds to each of the at least one vents of the outer shell.

11. The illuminated display apparatus of claim 8, wherein the top side of the second layer has one or more recessed segments sized to accommodate any lighting elements disposed between the outer shell and second layer.

12. The illuminated display apparatus of claim 8, wherein any lighting elements disposed between the outer shell and second layer comprise light emitting diodes.

13. The illuminated display apparatus of claim 8, wherein the first layer is formed as a sporting apparatus.
